(19) United States
(12) Patent Application Publication
(10) Pub. No.: US 2008/0165700 A1
(43) Pub. Date: Jul. 10, 2008

(54) Telephone with internet phone module

(76) Inventors: Kuo Ching Chiang, Linkou Township (TW); Yi Chuan Cheng, Yongjing Township (TW)

Correspondence Address: BIRCH STEWART KOLASCH & BIRCH, PO BOX 747, FALLS CHURCH, VA, 22040-0747, US

(21) Appl. No.: 11/649,857

(22) Filed: Jan. 5, 2007

(51) Int. Cl. H04L 12/28; G06F 17/00

(52) U.S. Cl. 370/254; 700/94

(57) ABSTRACT

The present invention discloses a telephone for communication via Internet comprising: a control unit, a display, memory coupled to the control unit; a converter coupled to the control unit for converting between digital and analog signal; a vocal I/O unit coupled to the converter; a MODEN coupled to the control unit; and an Internet phone module coupled to the control unit to allow a user may synchronously transmit or receive data through the Internet. The telephone further comprises a wireless local area network (WLAN) module coupled to the control unit. An image capturing device is coupled to the control unit.

### FIELD OF INVENTION

The present invention relates to a telephone, particularly to a telephone that is capable of providing communication service via internet.

### BACKGROUND OF INVENTION

Because of the development of the information technology (IT), the information could be exchanged with higher capacity and faster speed. Internet is designed as an open structure to exchange information freely without restriction. Thus, certain communication service requiring real time information exchange, such as viewing a live video, has become feasible through Internet. The VoIP (Voice over Internet Protocol) is a popular Internet protocol about the transmission of voice data packets. Conventionally, the VoIP operators are needed to obtain telephone lines from phone companies for linking themselves to the regular phone systems.

Currently, all of the VoIP are implanted in the computer system. The user has to power on the computer system while the user would like to place a call through the internet phone. Therefore, the applications of VoIP are still constrained within the computer. The general home user fails to benefit form the internet phone. It is inconvenient to the user.

### SUMMARY OF THE INVENTION

The present invention provides a communication system comprising: an internet network; a remote terminal coupled to the internet work; and a telephone with an internet phone module for communicating with the terminal through said telephone, wherein the internet phone module is coupled to a processing unit of the telephone, and a MODEN coupled to said processing unit to allow a user synchronously transmit or receive data through the internet network. The system further comprises a wireless local area network module coupled to the processing unit. The wireless local area network (WLAN) module includes Bluetooth standard compatible module, Wi-Fi standard compatible module, 802.11x standard compatible module, WiMAX (Worldwide Interoperability for Microwave Access) standard compatible module. Data includes audio signal, video signal, digital data and the combination thereof.

Another aspect of the present invention is a telephone for communication via Internet comprising: a control unit, a display, memory coupled to the control unit; a converter coupled to the control unit for converting between digital and analog signal; a vocal I/O unit coupled to the converter; a MODEN coupled to the control unit; and an Internet phone module coupled to the control unit to allow a user may synchronously transmit or receive data through the Internet. The present invention further comprises a wireless local area network (WLAN) module coupled to the control unit. An image capturing device is coupled to the control unit.

The present invention discloses a method for a telephone to communicate through an Internet, comprising: providing the telephone with an Internet phone module and a MODEN; coupling to the Internet via the MODEN; and transmitting or receiving data through the Internet via the MODEN by the Internet phone module, wherein the data is audio signal, video signal, digital data and the combination thereof.

A telephone system comprises an exchanging station including an exchanger coupled to a first processing unit; an internet phone module coupled to the first processing unit and an internet coupling module coupled to the processing unit for linking to an internet; and at least one telephone, each the at least one telephone includes a mode selection coupled to a second processing unit to allow a user selecting a mode between a internet phone mode and a PSTN phone mode, wherein the exchanger is coupled to the at least one telephone for exchanging call line, wherein the internet phone module allow the user making a internet phone call. The internet coupling module includes a MODEN or WLAN module coupled to the first processing unit.

### BRIEF DESCRIPTION OF THE DRAWING

For a better understanding of the present invention and to show how it may be implemented, reference will now be made to the following drawings:

FIG. 1 is a block diagram showing the telephone of the present invention.

FIG. 2 is a block diagram showing the telephone of the present invention.

FIG. 3 is a block diagram showing the telephone of the present invention.

FIG. 4 is a block diagram showing the telephone of the present invention.

FIG. 5 is a block diagram showing the telephone system of the present invention.

FIG. 6 is a block diagram showing the telephone system of the present invention.

FIG. 7 is a block diagram showing the telephone system of the present invention.

FIG. 8 is a block diagram showing the player of the present invention.

FIG. 9 is a block diagram showing the player of the present invention.

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments.

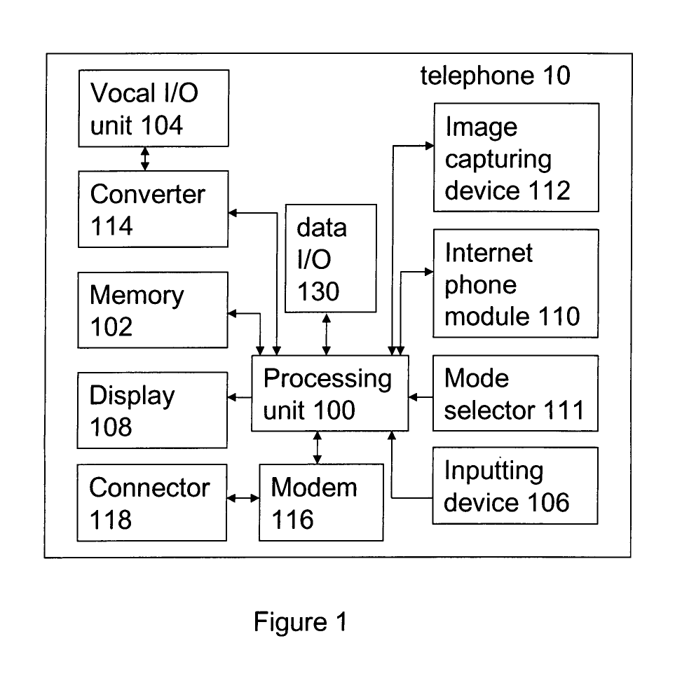

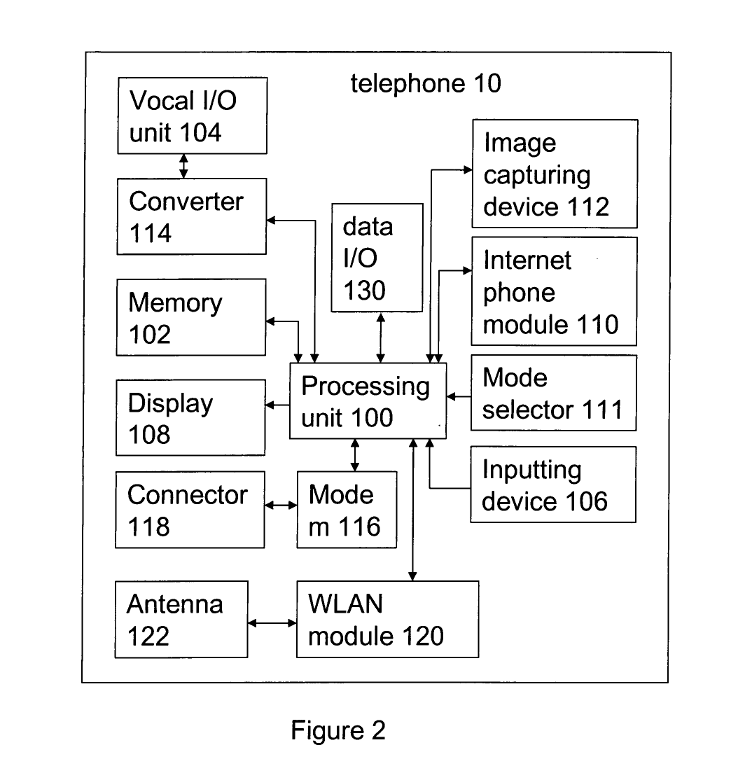

In FIG. 1, the present invention includes a wired PSTN telephone 10. The module can not process the mobile phone protocol such as a GSM, CDMA or PHS. In one case, it may process a local area network (LAN) protocol (refer to FIG. 2). It should be noted that the LAN capability is optional.

Referring to FIGS. 1 and 2, they illustrate the functional diagram of the present invention with internet phone capability. The diagram is used for illustrating and not used for limiting the scope of the present invention. As known, the telephone usually includes a final actuators, i.e. a vocal I/O unit 104 including loudspeaker and a microphone. The inputting device 106 is used to input the phone number or IP address of the receiver. Typically, the device 106 includes keypad, writing pad, vocal input module to input the number or IP address.

The device 10 includes converter (A/D, D/A) 114 for converting the data from digital to analog, vice versa. The present invention includes a processing unit 100, a build-in display 108 and memory 102. The memory 102 can be a ROM program memory, a RAM memory or a nonvolatile FLASH memory. All of the units mentioned above are coupled to the processing unit 100, respectively. The memory could be micro-type hard disc as well. A data I/O interface 130 is coupled to the processing unit 100 for exchanging information, such as phone number information, application software, updating version of VoIP program. The data I/O interface 130 could be USB, IEEE1394.

An Internet phone module 110 is coupled to the processing unit 100 to allow the PSTN telephone transmitting and receiving the audio, video or both type signal to/from the internet network without power on the computer or remote server. In one case, the Internet phone module 110 may meet the standard of Voice Over Internet Protocol (VoIP), it's update version or the like. An image capturing device 112 is required and coupled to the processing unit 100 to catch the video image if the user would like to conduct the real-time video transmission. The image capturing module 112 could be digital still camera or digital video camera. Therefore, the real-time conference is possible to be held through the PSTN telephone without the personal computer or laptop computer. A MODEN 116 is coupled to the processing unit 100 to modulate or demodulate the transmitted data to allow the telephone coupling to the internet. A connector 118 is coupled to the MODEN 116 to engage the PSTN telephone line. A mode selector 111 is coupled to the processing unit 100 to select between the mode of internet phone and the PSTN phone mode. When the internet phone mode is selected, the processing unit 100 will be responsive to the selection to couple to the internet. After the communication is completed and the user hooks the phone, the processing unit 100 will terminate the linking of the internet. If the user select the PSTN phone mode, the user may uses the phone 10 for conventional phone communication.

The telephone of FIG. 1 may couple to PSTN for linking to the home telephone system. The service relay may connect to the telephone with the link information through Internet. In another embodiment, the example further includes a wireless local area network (WLAN) module 120 coupled to the processing unit 100. An antenna 122 is provided to couple to the wireless local area network (WLAN) module 120 for transmitting or receiving signal from WLAN (wireless local area network), as shown in FIG. 2. The telephone may couple to the internet via the WLAN module 120 to upload or download data including digital data such as text format, image format, audio signal, video signal. The application of the apparatus is quite economical and convenience. Moreover, the user may call other one by the internet phone module to reduce the transmission fee. It should be noted that the present invention is performed without the computer. The portable real-time video conference is possible by implementation of the present invention. Further, the present invention provides dual way (transmission and receiving) portable audio/video communication, synchronously. The user may employ the home or public telephone to synchronously transmit and receive the vocal, video or both signal through the internet by using the internet phone module 110.

One aspect of the present invention is that the home (office) telephone 10 may further include a wireless local area network (WLAN) module 120. It could be compatible to the local area network protocol or standard such as Bluetooth standard, Wi-Fi standard or 802.11x standard compatible module. Further, the wireless local area network (WLAN) module could be compatible to the WiMAX (Worldwide Interoperability for Microwave Access) standard. Typically, the WLAN module may include transceiver, base-band unit, digital signal processing etc. The WLAN module is well known in the art, the detailed description is omitted.

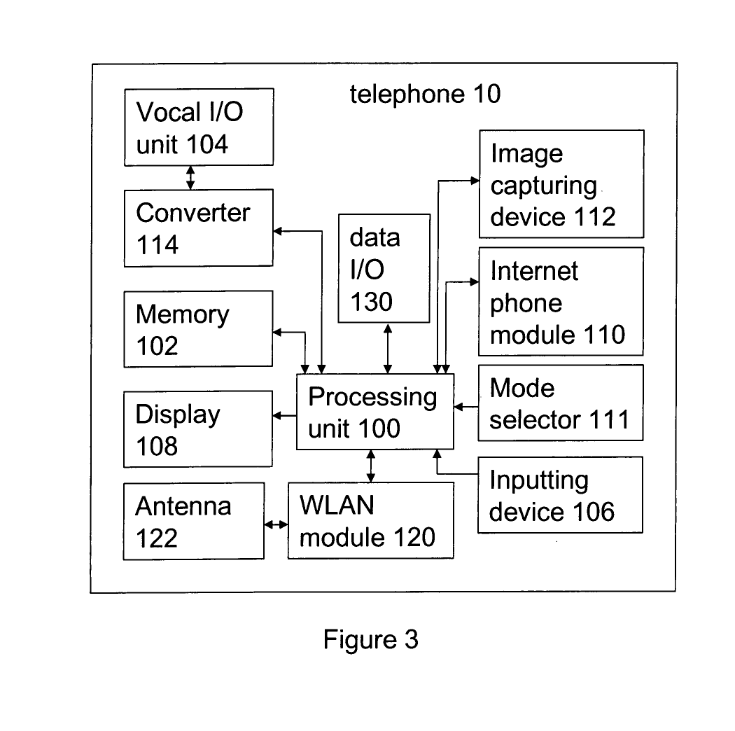

It is appreciated that the present invention may employ the WLAN module 120 to couple to the internet, as shown in FIG. 3.

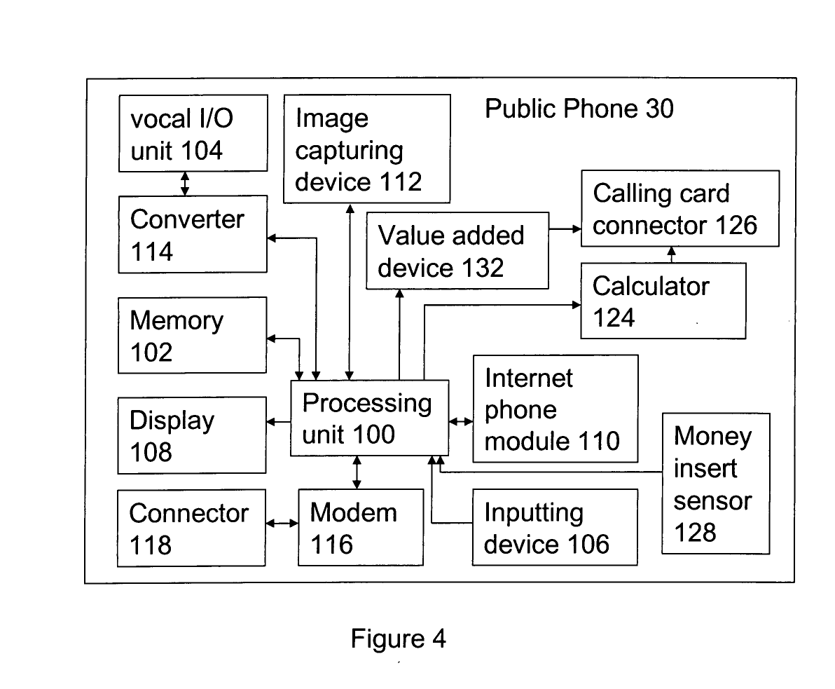

FIG. 4 illustrates another embodiment of the present invention for public internet telephone. The embodiment further includes a calling card connector 126 for inserting a telephone calling card to access the communication. A calculator 124 is coupled to the processing unit and the calling card connector 126 to calculate the calling time, and the communication fee based on the rate. Thereafter, the control unit updates the remaining credit of the calling card. The user may insert the money via slot to access the tele-communication, the money insert sensor 128 coupled to the processing unit 100 may be active to response the action. The calling card may be value-added by value-added device 132 when the user feed the money into the device 30.

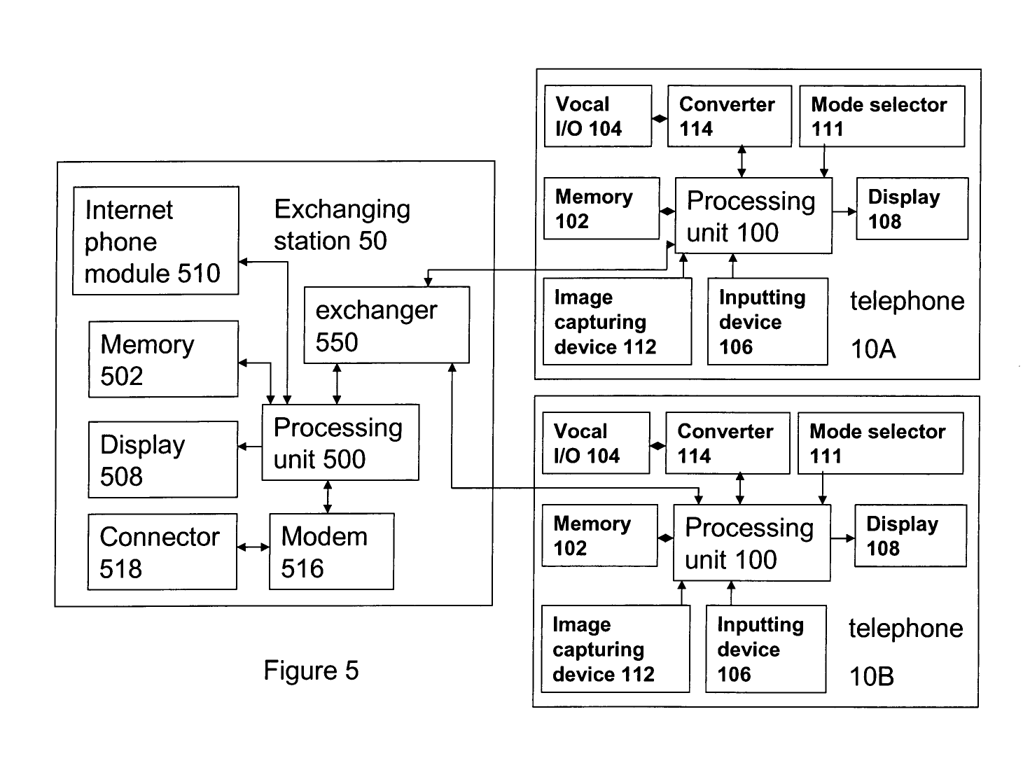

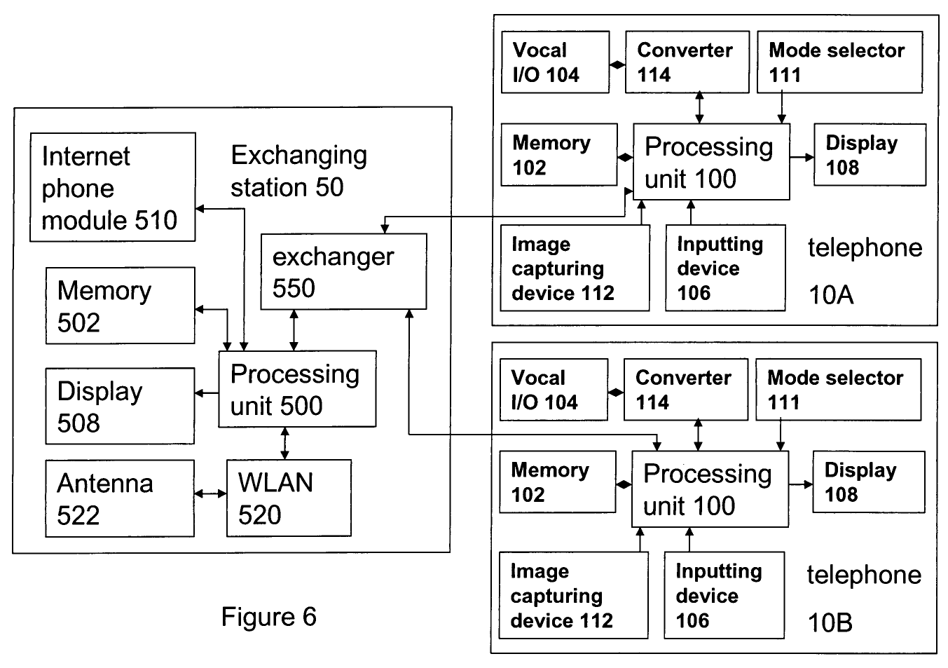

If multiple telephones are employed in a defined area, the multiple telephone may share the internet phone module 510 and the MODEN 516. Thus, the telephone 10A, 10B may omit the modules to save the cost and simplified the system. Please refer to FIG. 5 and FIG. 6, an exchanging station 50 is provided, the exchanging station 50 includes internet phone module 510 coupled to the processing unit 500. An exchanger 550 is coupled to the processing unit 500 for call line exchange. A MODEN 516 and connector 518 are coupled to the processing unit 500. Telephone 10A and telephone 10B are respectively coupled to the exchanger 550. The telephone 10A, 10B are similar to the telephone in FIG. 1-3. The exchanger 550 may perform the function of PSTN lines exchange and the internet phone line exchange. Preferably, the exchanger 550 may includes the VoSKY™ Exchange developed by Actiontec Electronics, Inc. For some application, a gateway maybe required, however, it is not the feature of the present invention.

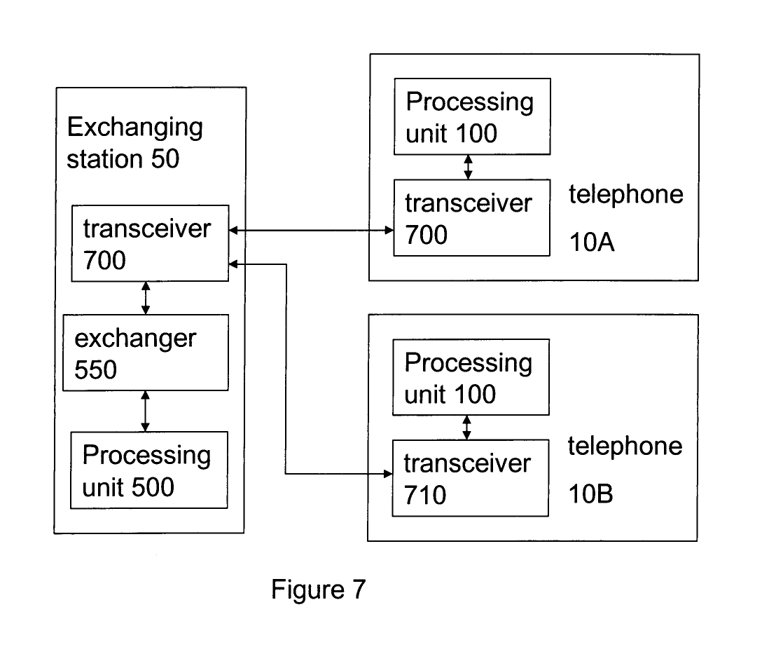

The coupling between the telephone 10A, 10B and the station 500 can be wired or wireless as shown in FIG. 7. In the embodiment, the exchanging station includes a transceiver 700 coupled to the processing unit 500. A transceiver 710 is provided to the telephone 10A, 10B, respectively. The communication protocol of the wireless communication can be Bluetooth standard, Wi-Fi standard or 802.11x standard compatible module. Further, the wireless local area network (WLAN) module could be compatible to the WiMAX (Worldwide Interoperability for Microwave Access) standard.

Therefore, the present invention may utilize the internet phone for real time communication without powering on the computer. Further, the communication cost can be reduced by the present invention. The user may alter the mode between the PSTN and internet phone. It will not change the operation custom of the user.

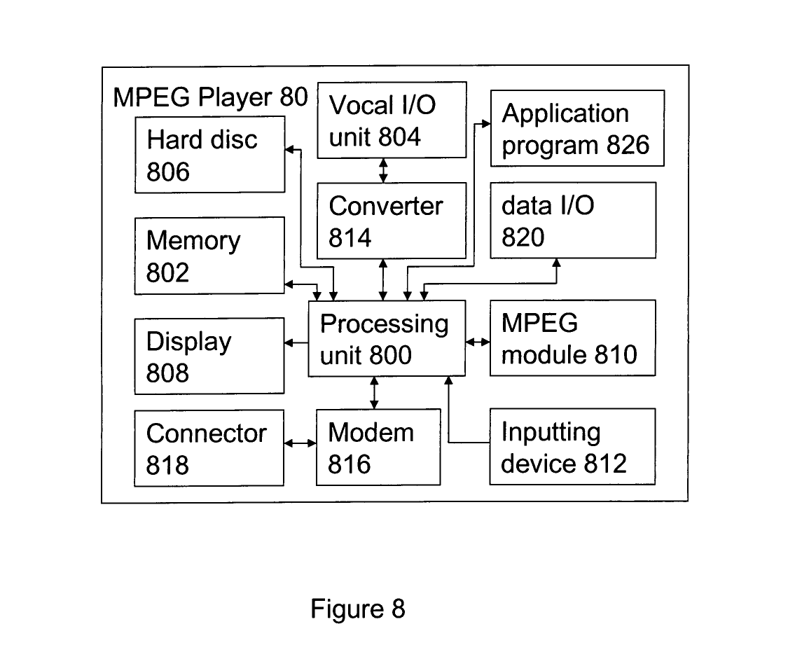

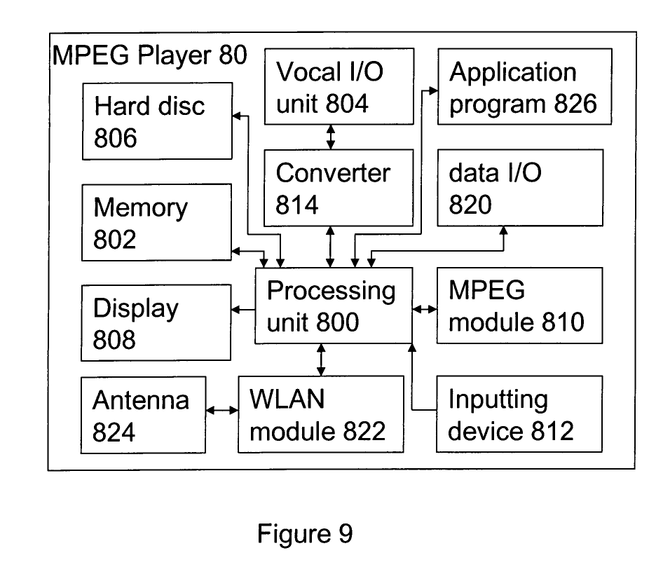

Referring to FIGS. 8 and 9, they illustrate the functional diagram of the portable MPEG player with MPEG module. The diagram is used for illustrating and not used for limiting the scope of the present invention. As known, the player 80 includes a final actuators, i.e. a vocal I/O unit 804 including loudspeaker and a microphone. The inputting device 812 is used to input the instruction of the user. Typically, the device 806 includes keypad, writing pad, vocal input module to input the number or IP address.

The device 80 includes converter (A/D, D/A) 184 for converting the data from digital to analog, vice versa. The present invention includes a processing unit 800, a build-in display 808, hard disc 806 and memory 802. The memory 802 can be a ROM program memory, a RAM memory or a nonvolatile FLASH memory. All of the units mentioned above are coupled to the processing unit 800, respectively. The memory could be micro-type hard disc as well. A data I/O interface 820 is coupled to the processing unit 800 for exchanging information, such as audio, video digital file, application software, updating version of program. The data I/O interface 820 could be USB, IEEE1394. A MPEG module 810 is couple to the processing unit 800 to play or drive the audio, video digital file, for instance, MP3, MP4 specification file, stored in the hard disc 806.

A MODEN 816 is coupled to the processing unit 800 and a connector 818 is connected to the MODEN. The MODEN allows the player 80 coupling to an internet network and transmitting, receiving data via the internet. Therefore, the user may employ the player 80 download the audio, video data via the internet without powering on the computer. Currently, all of the files are downloaded via the computer, followed by transfer the file from the computer to the player. The present invention may transfer (download or upload) the file directly. The player 80 may transfer the data by linking the web or by e-mail via the internet. As known, the player 80 may include application program 826, for instance OS, application software, web browser or e-mail program etc. The application program 826 allows the player 80 linking to web or processing e-mail for transferring data, portably without powering on the computer. The software program is not the feature of the present invention, the description is omitted. Alternatively, the players 80 may employ the WLAN 822 to couple to the internet for data transferring. The WLAN 822 is couple to the processing unit 800 and antenna 824 is coupled to the WLAN 822.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A communication system comprising:
an internet network;
a remote terminal coupled to said internet work; and
a telephone with an internet phone module for communicating with said terminal through said telephone, wherein said internet phone module is coupled to a processing unit of said telephone, and a MODEN coupled to said processing unit to allow a user transmitting or receiving data through said inter network.

2. The system as set forth in claim 1, further comprising a wireless local area network module coupled to said processing unit.

3. The portable device as set forth in claim 2, wherein said wireless local area network (WLAN) module includes Bluetooth standard compatible module, Wi-Fi standard compatible module, 802.11x standard compatible module, WiMAX (Worldwide Interoperability for Microwave Access) standard compatible module.

4. A telephone for communication via Internet comprising:
a control unit,
a display, memory coupled to said control unit;
a converter coupled to said control unit for converting between digital and analog signal;
a vocal I/O unit coupled to said converter;
a wireless local area network (WLAN) module coupled to said control unit; and
an Internet phone module coupled to said control unit to allow a user transmitting or receiving data through said Internet.

5. The telephone as set forth in claim 4, further comprising an image capturing device coupled to said control unit.

6. The telephone as set forth in claim 4, further comprising a display coupled to said control unit.

7. The telephone as set forth in claim 4, wherein said wireless local area network (WLAN) module includes Bluetooth standard compatible module, Wi-Fi standard compatible module, 802.11x standard compatible module or WiMAX (Worldwide Interoperability for Microwave Access) standard compatible module.

8. A telephone for communication via Internet comprising:
a control unit,
a display, memory coupled to said control unit;
a converter coupled to said control unit for converting between digital and analog signal;
a vocal I/O unit coupled to said converter;
a MODEN coupled to said control unit; and
an Internet phone module coupled to said control unit to allow a user transmitting or receiving data through said Internet.

9. The telephone as set forth in claim 8, further comprising a wireless local area network (WLAN) module coupled to said control unit.

10. The telephone as set forth in claim 9, wherein said wireless local area network (WLAN) module includes Bluetooth standard compatible module, Wi-Fi standard compatible module, 802.11x standard compatible module or WiMAX (Worldwide Interoperability for Microwave Access) standard compatible module.

11. The telephone as set forth in claim 8, further comprising an image capturing device coupled to said control unit.

12. The telephone as set forth in claim 8, further comprising a display coupled to said control unit.

13. The telephone as set forth in claim 8, further comprising a calculator coupled to said control unit and a calling card connector coupled to said calculator.

14. The telephone as set forth in claim 8, further comprising a money insert sensor coupled to said control unit and a value added device coupled to said control unit.

15. A telephone system, comprising:
an exchanging station including an exchanger coupled to a first processing unit; an internet phone module coupled to said first processing unit and an internet coupling module coupled to said processing unit for linking to an internet; and
at least one telephone, each said at least one telephone includes a mode selection coupled to a second processing unit to allow a user selecting a mode between a internet phone mode and a PSTN phone mode, wherein said exchanger is coupled to said at least one telephone for exchanging call line, wherein said internet phone module allow said user making a internet phone call.

16. The telephone system as set forth in claim 15, wherein said internet coupling module includes a MODEN coupled to said first processing unit.

17. The telephone system as set forth in claim 15, wherein said internet coupling module includes a WLAN module coupled to said first processing unit.

18. The telephone system as set forth in claim 15, wherein a first transceiver is coupled to said exchanger and a second transceiver is coupled to said second processing unit.

19. A method for a telephone to communicate through an Internet, comprising:
providing said telephone with an Internet phone module and a MODEN;
coupling to said Internet via said MODEN;
transmitting or receiving data through said Internet via said MODEN by said Internet phone module, wherein said data is audio signal, video signal, digital data and the combination thereof.

20. The method as set forth in claim 19, wherein said telephone comprising a wireless local area network (WLAN) module that includes Bluetooth standard compatible module, Wi-Fi standard compatible module, includes 802.11x standard compatible module or WiMAX (Worldwide Interoperability for Microwave Access) standard compatible module.

21. The method as set forth in claim 19, further comprising a step of capturing an image by an image capturing device during calling.

22. A method for a telephone to communicate through an Internet, comprising:
providing said telephone with an Internet phone module and a WLAN module;
coupling to said Internet via said WLAN module;
transmitting or receiving data through said Internet via said WLAN module by said Internet phone module, wherein said data is audio signal, video signal, digital data and the combination thereof.

23. The method as set forth in claim 22, wherein said WLAN module that includes Bluetooth standard compatible module, Wi-Fi standard compatible module, includes 802.11x standard compatible module or WiMAX (Worldwide Interoperability for Microwave Access) standard compatible module.

24. The method as set forth in claim 22, further comprising a step of capturing an image by an image capturing device during calling.

25. A portable media player comprising:
a control unit,
a converter coupled to said control unit for converting data between digital and analog signal;
a vocal I/O unit coupled to said converter;
an audio or video playing module coupled to said control unit;
a wireless local area network (WLAN) module coupled to said control unit for coupling an internet; and
application program coupled to said control unit to allow said portable media player transmitting or receiving data through said Internet.

26. The telephone as set forth in claim 25, wherein said wireless local area network (WLAN) module includes Bluetooth standard compatible module, Wi-Fi standard compatible module, 802.11x standard compatible module or WiMAX (Worldwide Interoperability for Microwave Access) standard compatible module.

27. A portable media player comprising:
a control unit,
a coupled to said control unit;
a converter coupled to said control unit for converting data between digital and analog signal;
a vocal I/O unit coupled to said converter;
an audio or video playing module coupled to said control unit;
a MODEN coupled to said control unit for coupling an internet; and
application program coupled to said control unit to allow said portable media player transmitting or receiving data through said Internet.
